(19) United States
(12) Patent Application Publication
(10) Pub. No.: US 2018/0109870 A1
(43) Pub. Date: Apr. 19, 2018

(54) MOBILE CALL DEVICE AND DUAL FREQUENCY RECEIVER USED THEREBY

(71) Applicant: Jetvox Acoustic Corp., Taoyuan (TW)

(72) Inventor: To-Teng HUANG, Taoyuan (TW)

(21) Appl. No.: 15/455,516

(22) Filed: Mar. 10, 2017

(30) Foreign Application Priority Data
Oct. 14, 2016 (TW) 105215699

(51) Int. Cl. H04R 1/22; H04R 1/24; H04R 3/14; H04R 17/00

(52) U.S. Cl. CPC H04R 1/225; H04R 1/24; H04R 2499/11; H04R 17/005; H04R 3/14

(57) ABSTRACT

A mobile call device includes a housing having a received-sound outputting opening, a sound device for outputting a sound signal, a frequency-dividing circuit electrically connected to the sound device to receive the sound signal and dividing the sound signal into a low-frequency signal and a high frequency signal, and a dual frequency receiver assembled in the housing and corresponding to the received-sound outputting opening. The dual frequency receiver includes a mount including a first fixing member and a second fixing member, a ceramic vibration member fixedly assembled to the second fixing member and electrically connected to the frequency-dividing circuit to receive the high-frequency signal, and a receiver component fixedly assembled to the first fixing member and including a sound-outputting portion corresponding to and facing the ceramic vibration member. The receiver component is electrically connected to the frequency-dividing circuit to receive the low-frequency signal.

### CROSS-REFERENCE TO RELATED APPLICATION

This non-provisional application claims priority under 35 U.S.C. § 119(a) to Patent Application No. 105215699 filed in Taiwan, R.O.C. on Oct. 14, 2016, the entire contents of which are hereby incorporated by reference.

### BACKGROUND

### Technical Field

The instant disclosure relates to a mobile call device, in particular, to a mobile call device with a dual frequency receiver.

### Related Art

Conventional mobile call device, e.g., a mobile phone or a tablet with call function, has a receiver (i.e., a microspeaker) corresponding to the sound outputting opening of the device, and the microspeaker corresponds to the ear of a user upon operation. Therefore, the user can receive the sounds via the microspeaker to catch the call.

The functions of the mobile call device increase and change along with the march of time forwards. A nowadays receiver can be provided for the user in listening to music or for performing sound effects in games. Hence, the quality of the sound outputted by the mobile call device is further concerned. The frequency response generated by the conventional receiver encounters a severe decay in the high-frequency range. Therefore, in the high-frequency range, the outputted sound has distortion problems.

### SUMMARY

In order to solve the distortion problem in the high-frequency range met by the conventional, a mobile call device and a dual frequency receiver used thereby are provided. One embodiment of the mobile call device comprises a housing, a sound device, a frequency-dividing circuit, and a dual frequency receiver. The housing has a received-sound outputting opening for outputting sounds. The sound device outputs a sound signal. The frequency-dividing circuit is electrically connected to the sound device and adapted to receive the sound signal. The frequency-dividing circuit divides the sound signal into a low-frequency signal and a high frequency signal. The dual frequency receiver is assembled in the housing and corresponding to the received-sound outputting opening. The dual frequency receiver comprises a mount, a ceramic vibration member, and a receiver component. The mount comprises a first fixing member and a second fixing member. The ceramic vibration member is fixedly assembled to the second fixing member and electrically connected to the frequency-dividing circuit to receive the high-frequency signal. The receiver component is fixedly assembled to the first fixing member. The receiver component comprises a sound-outputting portion corresponding to and facing the ceramic vibration member. The receiver component is electrically connected to the frequency-dividing circuit to receive the low-frequency signal.

In this embodiment, the ceramic vibration member and the receiver component are assembled with each other via the mount. Further, the sound signals are divided into different frequencies by the frequency-dividing circuit, and the high-frequency signal and the low-frequency signal are respectively transmitted to the ceramic vibration member and the receiver component. Therefore, the response in the high-frequency range can be improved, and the sound can have better effect.

In one embodiment, the frequency-dividing circuit is assembled on the mount. In other words, the frequency-dividing circuit and the dual frequency receiver can be combined to form a single module.

In one embodiment, the mobile call device further comprises a sound buffering member located on a surface of the ceramic vibration member for adjusting the response frequency.

A dual frequency receiver is also provided, and the dual frequency receiver is used in the mobile call device. One embodiment of the dual frequency receiver comprises a mount, a ceramic vibration member, and a receiver component. The mount comprises a first fixing member and a second fixing member. The ceramic vibration member is fixedly assembled to the second fixing member. The receiver component is fixedly assembled to the first fixing member. The receiver component comprises a sound-outputting portion corresponding to and facing the ceramic vibration member.

In one embodiment, the dual frequency receiver further comprises a frequency-dividing circuit electrically connected to the receiver component and the ceramic vibration member, respectively. The frequency-dividing circuit divides a sound signal into a low-frequency signal and a high-frequency signal, transmits the high-frequency signal to the ceramic vibration member, and transmits the low-frequency signal to the receiver component. Furthermore, the frequency-dividing circuit is assembled on the mount. In other words, the frequency-dividing circuit and the dual frequency receiver can be combined to form a single module.

In one embodiment, the mount comprises a first surface and a second surface at opposite sides thereof. The mount comprises a through hole for communicating between the first surface and the second surface. The through hole corresponds to the sound-outputting portion and the ceramic vibration member.

In one embodiment, the first fixing member comprises at least two protruding blocks protruding from the first surface of the mount, and the receiver component is engaged between the protruding blocks.

In one embodiment, the second fixing member comprises a receiving cavity recessed from the second surface of the mount, and the ceramic vibration member is received in the receiving cavity. Moreover, an upper surface of the ceramic vibration member is flush with the second surface.

In one embodiment, the second fixing member further comprises at least one recess recessed toward the first surface from a portion of the second surface and communicating with the through hole.

In one embodiment, the dual frequency receiver further comprises a sound buffering member on a surface of the ceramic vibration member.

Based on the above, the mobile call device and the dual frequency receiver used by the mobile call device comprise the ceramic vibration member and the receiver component to form the dual frequency receiver. The ceramic vibration member and the receiver component can output sounds with different frequencies by frequency dividing, thereby improving the sound resolution outputted by the mobile call device.

### BRIEF DESCRIPTION OF THE DRAWINGS

The disclosure will become more fully understood from the detailed description given herein below for illustration only, and thus not limitative of the disclosure, wherein:

FIG. 1 illustrates an exploded view of a mobile call device according to an exemplary embodiment of the instant disclosure;

FIG. 2 illustrates a partial sectional view of the mobile call device of FIG. 1;

FIG. 3 illustrates a perspective view of a dual frequency receiver according to an exemplary embodiment of the instant disclosure;

FIG. 4 illustrates an exploded view (1) of the dual frequency receiver of FIG. 3;

FIG. 5 illustrates an exploded view (2) of the dual frequency receiver of FIG. 3;

FIG. 6 illustrates a partial sectional view of a ceramic vibration member of the dual frequency receiver of FIG. 3; and

FIG. 7 illustrates a frequency response graph of the dual frequency receiver of FIG. 3.

### DETAILED DESCRIPTION

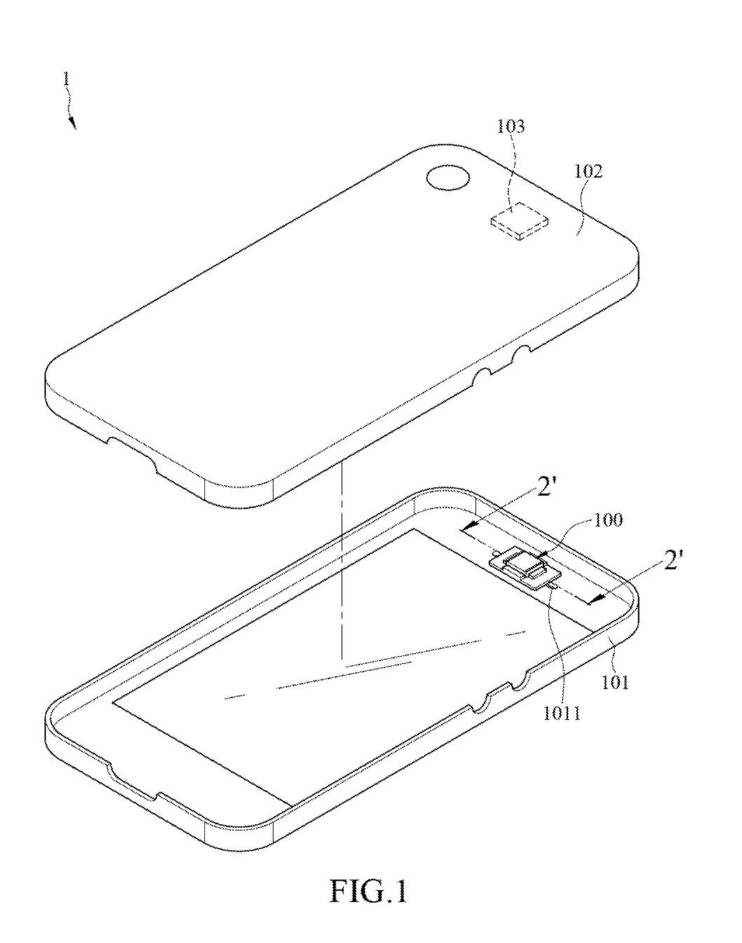

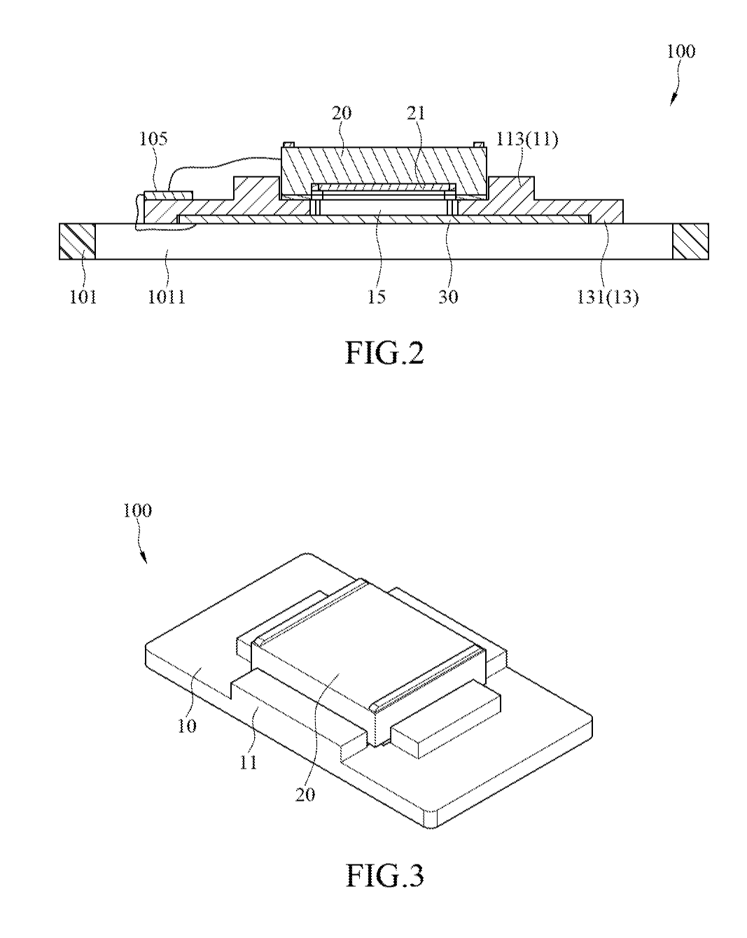

Please refer to FIGS. 1 and 2, respectively illustrating an exploded view and a partial sectional view of a mobile call device according to an exemplary embodiment of the instant disclosure, wherein FIG. 2 is a sectional view based on the line 2-2′ of FIG. 1. As shown in FIGS. 1 and 2, the mobile call device 1 comprises a dual frequency receiver 100, a housing 101, a body 102, a sound device 103, and a frequency-dividing circuit 105. The housing 101 is correspondingly assembled to the surface of the body 102 and the housing 101 has a received-sound outputting opening 1011. In general, the received-sound outputting opening 1011 corresponds to the ear of a user. The sound device 103 is located on the body 102 for outputting a sound signal, e.g., voice or music. The dual frequency receiver 100 is assembled in the housing 101 and corresponding to the received-sound outputting opening 1011. In other words, dual frequency sounds generated by the dual frequency receiver 100 are outputted by the received-sound outputting opening 1011 and further delivered to the ear of the user.

The frequency-dividing circuit 105 is electrically connected to the sound device 103 and the dual frequency receiver 100. The frequency-dividing circuit 105 may be implemented by a printed circuit board or a flexible printed circuit board, or may be a partial circuit of the motherboard of the mobile call device 1. Therefore, the frequency-dividing circuit 105 may be assembled to the body 102 or may be assembled on the dual frequency receiver 100. The frequency-dividing circuit 105 is for dividing the sound signal into a high-frequency signal and a low-frequency signal. For example, the frequency-dividing circuit 105 divides the sound signal into high-frequency signals with a range in 2 KHz to 40 KHz and low-frequency signals with a range in 1 Hz to 2 KHz. Alternatively, the frequency-dividing circuit 105 divides the sound signal into high-frequency signals with a range in 10 KHz to 40 KHz and low-frequency signals with a range in 1 Hz to 10 KHz. The foregoing examples are for illustration, embodiments of the frequency-dividing circuit 105 are not limited thereto. It is understood that the frequency-dividing circuit 105 can perform any frequency dividing method capable of dividing a sound signal into a high-frequency signal and a low-frequency signal. Moreover, the range of the high-frequency signal and the range of the low-frequency signal may be partially overlapped or not overlapped.

Please refer to FIGS. 3 to 5, respectively illustrating a perspective view, an exploded view (1), and an exploded view (2) of a dual frequency receiver 100 according to an exemplary embodiment of the instant disclosure. As shown in FIGS. 2 to 5, the dual frequency receiver 100 comprises a mount 10, a receiver component 20, and a ceramic vibration member 30. The mount 10 comprises a first fixing member 11 and a second fixing member 13. The receiver component 20 is fixedly assembled to the first fixing member 11. The receiver component 20 comprises a sound-outputting portion 21 for outputting sounds. The sound-outputting portion 21 corresponds to and faces the ceramic vibration member 30. The receiver component 20 is electrically connected to the frequency-dividing circuit 105 to receive the low-frequency signal, and the receiver component 20 generates a low-frequency sound according to the low-frequency signal. The ceramic vibration member 30 is fixedly assembled to the second fixing member 13. The ceramic vibration member 30 is electrically connected to the frequency-dividing circuit 105 to receive the high-frequency signal, and the ceramic vibration member 30 generates a high-frequency sound according to the high-frequency signal. Moreover, the ceramic vibration member 30 corresponds to the received-sound outputting opening 1011. Therefore, the dual frequency receiver 100 can output sounds in dual frequencies which are the combination of low-frequency sound from the receiver component 20 and high-frequency sound from the ceramic vibration member 30.

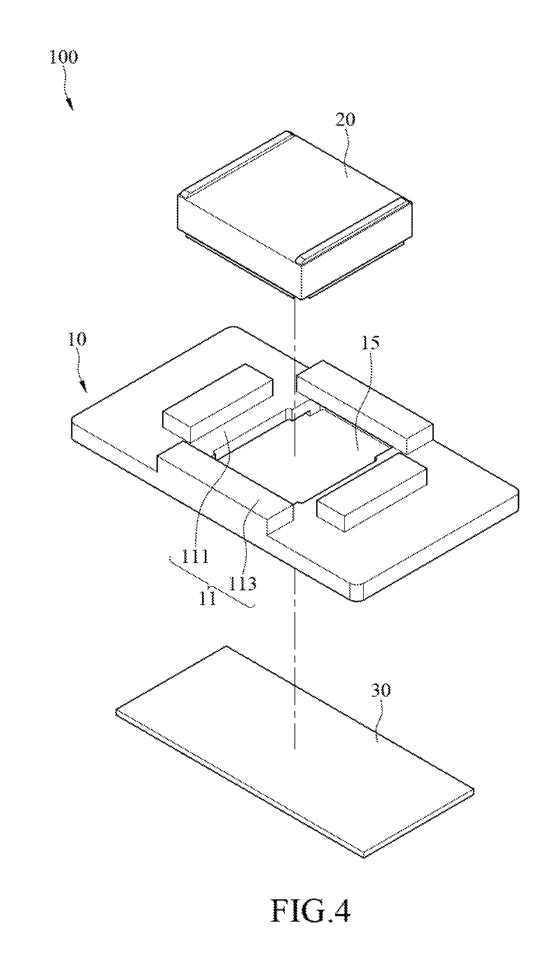

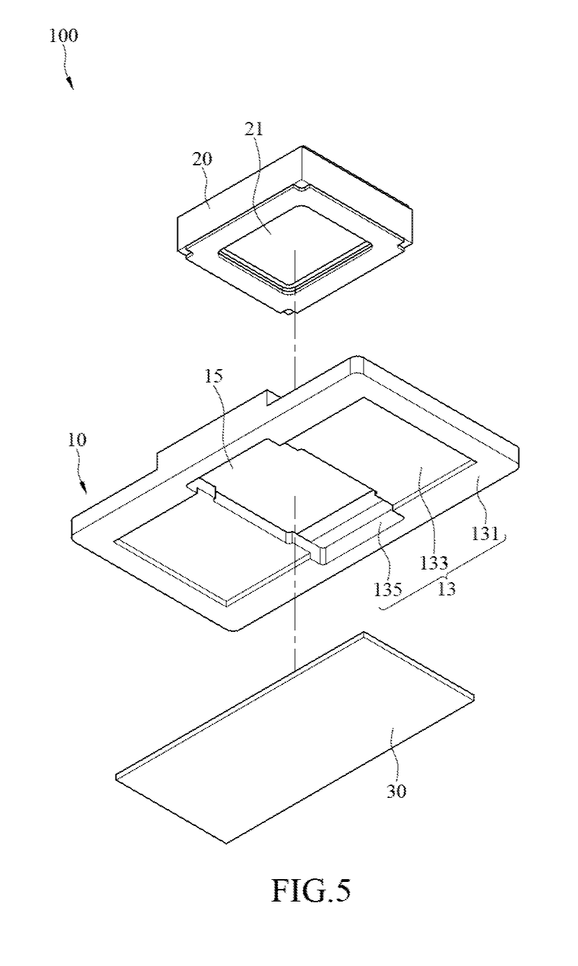

In detail, as shown in FIG. 4, the first fixing member 11 comprises at least two protruding blocks 113 protruding from a first surface 111 of the mount 10, and the receiver component 20 is engaged between the protruding blocks 113. For example, the first fixing member 11 may comprise four protruding blocks 113, and four sides of the receiver component 20 are respectively abut against and positioned with the four protruding blocks 113. As shown in FIG. 5, the second fixing member 13 comprises a receiving cavity 133 recessed from a second surface 131 of the mount 10, and the ceramic vibration member 30 is received in the receiving cavity 133. In detail, a periphery of the ceramic vibration member 30 is abutted against the second surface 131, so that the ceramic vibration member 30 is positioned in the receiving cavity 133. Furthermore, after the ceramic vibration member 30 is received in the receiving cavity 133, an upper surface of the ceramic vibration member 30 is flush with the second surface 131. In other words, the upper surface of the ceramic vibration member 30 and the second surface 131 of the mount 10 are at the same plane to abut against the received-sound outputting opening 1011.

In this embodiment, the first surface 111 and the second surface 131 are opposite surfaces of the mount 10, and the protruding blocks 113 are protruding away from the second surface 113. The mount 10 further comprises a through hole 15 communicating between the first surface 111 and the second surface 131. The through hole 15 may be on a center portion of the mount 10, and the through hole 15 corresponds to the sound-outputting portion 21 of the receiver component 20 and the ceramic vibration member 30. In other words, the low-frequency sound generated by the receiver component 20 will be transmitted to the through hole 15 and combined with the high-frequency sound generated by the ceramic vibration member 30 for outputting.

Furthermore, as shown in FIGS. 4 and 5, the second fixing member 13 further comprises a recess 135. In this embodiment, the second fixing member 13 comprises two recesses 135 at two sides, e.g., two longitudinal sides or two transversal sides, thereof. The recess 135 is recessed toward the first surface 111 from a portion between two sides of the second surface 131, and the recesses 135 communicate with the through hole 15. In this embodiment, the recess 135 may be provided as a sound delivering hole for the low-frequency sound generated by the receiver component 20, or may further be provided as a via hole for inserting a fixture to place the ceramic vibration member 30 on the mount 10. Furthermore, a periphery of the ceramic vibration member 30 and the periphery of the sound-outputting portion 21 of the receiver component 20 may be fixed on the mount 10 by adhesive tapes to prevent from the falling of the components.

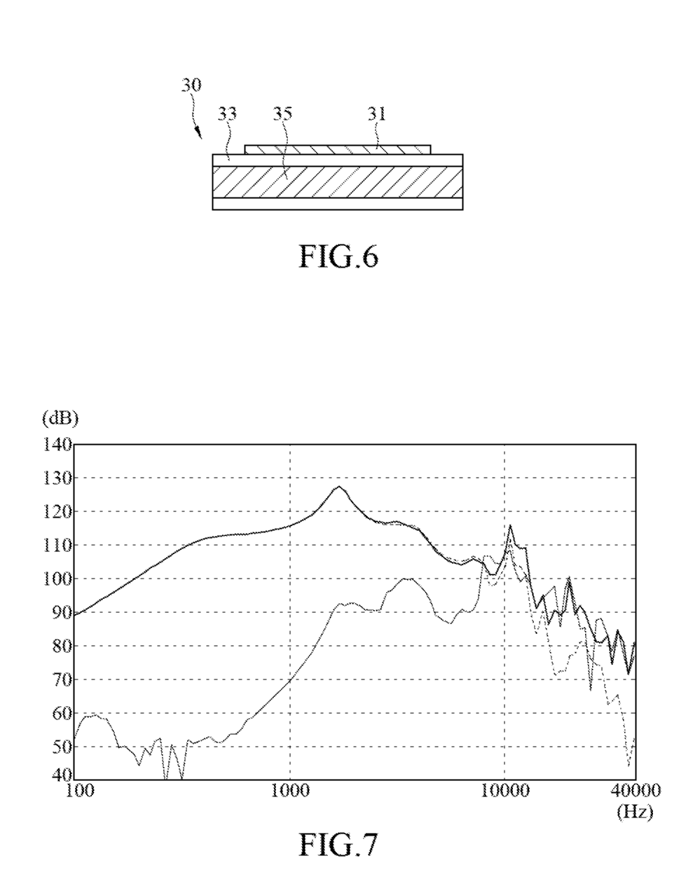

Please refer to FIG. 6, illustrating a partial sectional view of the ceramic vibration member 30 of the dual frequency receiver 100. A sound buffering member 31 may be assembled on a surface of the ceramic vibration member 30. The sound buffering member 30 may be a pad for adjusting the frequency of the outputted sounds. Therefore, the dual frequency receiver 100 can perform filtering or adjustment by the sound buffering member 31 according to the features of the receiver component 20 and the ceramic vibration member 30 to meet different user requirements.

Moreover, the ceramic vibration member 30 may be made of composite materials. In general, the ceramic vibration member 30 has a thicker flexible layer coated with ceramic materials for outputting high-frequency sounds to perform a better resonance effect. For instance, the ceramic vibration member 30 may be a three-layered structure in which the middle layer is a metal plate 35 and the metal plate 35 is coated by ceramic films 33. Hence, the ceramic vibration member 30 may achieve greater amplitude by the metal plate 35. It is understood that, the foregoing description about the structure of the ceramic vibration member 30 is for illustrative purpose, embodiments of the ceramic vibration member 30 are not limited thereto.

Please refer to FIG. 7, illustrating a frequency response graph of the dual frequency receiver. As shown in FIG. 7, the transversal axis of the graph is frequency, and the unit of frequency is hertz (Hz); the unit of the longitudinal axis of the graph is decibel (dB). In the figure, the solid line is a frequency response curve of a dual frequency receiver having both the receiver component and the ceramic vibration member, the dotted line is a frequency response curve of a conventional receiver component, and the thin solid line is a frequency response curve of a full ceramic receiver. As shown in FIG. 7, it is understood that, the conventional receiver component encounters severe response decay in the high-frequency range. Therefore, the outputted sound has serious distortion problems in the high-frequency range. As a result, the resolution performance of the conventional receiver component is worse. In the middle to low frequency range, the performance of the ceramic receiver is obviously worse than the conventional receiver component, and the cost of the ceramic receiver is expensive. As a result, the ceramic receiver cannot meet the user requirements. The dual frequency receiver performs good response in low-frequency, middle-frequency, and high-frequency ranges. Hence, the dual frequency receiver has both the advantages of the conventional receiver component and the ceramic receiver. Consequently, the resolution performance of the mobile call device can be efficiently improved.

In addition, the operation modes of the mobile call device can be switched by a sensor, e.g., the sensor can control the volume of the sound outputted by the dual frequency receiver. When the mobile call device is near the user, the amplitude of the sound is limited, and the dual frequency receiver is switched to a receiver mode for outputting sounds with low volumes. Conversely, when the mobile call device is away from the user, the volume of the sound outputted by the mobile call device can be loudened, and the dual frequency receiver is served as a speaker and switched to an amplified mode. The dual frequency receiver in the amplified mode may further be accomplished by a preset speaker to generate multichannel sounds in a theater mode. It is understood that, the abovementioned operation modes are provided for illustrative purposes, but not a limitation to the mobile call device of the instant disclosure.

Based on the above, the mobile call device and the dual frequency receiver used by the mobile call device comprise the ceramic vibration member and the receiver component to form the dual frequency receiver. The ceramic vibration member and the receiver component can output sounds with different frequencies by frequency dividing, thereby improving the sound resolution outputted by the mobile call device.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A mobile call device, comprising:
a housing having a received-sound outputting opening;
a sound device for outputting a sound signal;
a frequency-dividing circuit electrically connected to the sound device and adapted to receive the sound signal, wherein the frequency-dividing circuit further divides the sound signal into a low-frequency signal and a high-frequency signal; and
a dual frequency receiver assembled in the housing and corresponding to the received-sound outputting opening, wherein the dual frequency receiver comprises a mount, a ceramic vibration member, and a receiver component, wherein:
the mount comprises a first fixing member and a second fixing member;
the ceramic vibration member is fixedly assembled to the second fixing member and electrically connected to the frequency-dividing circuit to receive the high-frequency signal; and
the receiver component is fixedly assembled to the first fixing member, the receiver component comprises a sound-outputting portion corresponding to and facing the ceramic vibration member, the receiver component is electrically connected to the frequency-dividing circuit to receive the low-frequency signal.

2. The mobile call device according to claim 1, wherein the frequency-dividing circuit is assembled on the mount.

3. The mobile call device according to claim 1, further comprising a sound buffering member located on a surface of the ceramic vibration member.

4. A dual frequency receiver, comprising:
a mount comprising a first fixing member and a second fixing member;
a ceramic vibration member fixedly assembled to the second fixing member; and
a receiver component fixedly assembled to the first fixing member, wherein the receiver component comprises a sound-outputting portion corresponding to and facing the ceramic vibration member.

5. The dual frequency receiver according to claim 4, further comprising a frequency-dividing circuit electrically connected to the receiver component and the ceramic vibration member, respectively, wherein the frequency-dividing circuit divides a sound signal into a low-frequency signal and a high-frequency signal, transmits the high-frequency signal to the ceramic vibration member, and transmits the low-frequency signal to the receiver component.

6. The dual frequency receiver according to claim 5, wherein the frequency-dividing circuit is assembled on the mount.

7. The dual frequency receiver according to claim 4, wherein the mount comprises a first surface and a second surface at opposite sides thereof, the mount comprises a through hole for communicating between the first surface and the second surface, the through hole corresponds to the sound-outputting portion and the ceramic vibration member.

8. The dual frequency receiver according to claim 7, wherein the first fixing member comprises at least two protruding blocks protruding from the first surface of the mount, and the receiver component is engaged between the protruding blocks.

9. The dual frequency receiver according to claim 7, wherein the second fixing member comprises a receiving cavity recessed from the second surface of the mount, and the ceramic vibration member is received in the receiving cavity.

10. The dual frequency receiver according to claim 9, wherein an upper surface of the ceramic vibration member is flush with the second surface.

11. The dual frequency receiver according to claim 9, wherein the second fixing member further comprises at least one recess recessed toward the first surface from a portion of the second surface and communicating with the through hole.

12. The dual frequency receiver according to claim 4, further comprising a sound buffering member on a surface of the ceramic vibration member.
